(19) United States
(12) Patent Application Publication
(10) Pub. No.: US 2011/0044162 A1
(43) Pub. Date: Feb. 24, 2011

(54) METHOD OF FLUSHING FILTERING DATABASE IN ETHERNET RING NETWORK

(75) Inventors: Jeong-dong RYOO, Daejeon (KR); Kyu Sang LEE, Seoul (KR); Susang YOO, Seoul (KR)

Correspondence Address: NELSON MULLINS RILEY & SCARBOROUGH LLP;FLOOR 30, SUITE 3000, ONE POST OFFICE SQUARE, BOSTON, MA, 02109, US

(73) Assignees: Electronics and Telecommunications Research Institute, Daejeon (KR); Actus Networks, Inc., Seoul (KR)

(21) Appl. No.: 12/862,279

(22) Filed: Aug. 24, 2010

(30) Foreign Application Priority Data
Aug. 24, 2009 (KR) 10-2009-0078345
Jun. 3, 2010 (KR) 10-2010-0052417

(51) Int. Cl. G06F 11/00

(52) U.S. Cl. 370/216

(57) ABSTRACT

A method in which a node of an Ethernet ring network flushes a filtering database includes operating a timer for delaying flushing of the filtering database when a topology of the ring network is changed, and flushing the filtering database when the timer is terminated. A method in which a node of an Ethernet ring network flushes a filtering database includes flushing the filtering database after receiving a protection switching frame that requests flushing of the filtering database, and forwarding a data frame in a queue state at a node and then forwarding the protection switching frame to an adjacent node. A method in which a node of an Ethernet ring network flushes a filtering database includes flushing the filtering database after receiving a protection switching frame that requests flushing of the filtering database, and deleting a data frame in a queue state at the node.

### CROSS-REFERENCE TO RELATED APPLICATION

This application claims priority to and the benefit of Korean Patent Application Nos. 10-2009-0078345 and 10-2010-0052417 filed in the Korean Intellectual Property Office on Aug. 24, 2009 and Jun. 3, 2010, the entire contents of which are incorporated herein by reference.

### BACKGROUND OF THE INVENTION

(a) Field of the Invention

The present invention relates to a method of flushing a filtering database in an Ethernet ring network.

(b) Description of the Related Art

An Ethernet ring network forms a ring by connecting a port of each node to a port of an adjacent node, and prevents a loop from occurring by logically blocking a predetermined specific port among several ports of the ring. Here, because a logical block port is physically connected and is only logically blocked, when a logical block is removed, the block port can immediately transmit traffic. In this way, a ring protection link (RPL) is set as a link for a logical block, and an RPL owner node that manages a block of the RPL is connected to one end of the RPL.

When a position of the block is changed in an Ethernet ring network, a network topology is changed. When a block is changed at a node due to a cause such as a signal failure, the node having the changed block flushes a filtering database (FDB), generates a ring-automatic protection switching (R-APS) frame that controls protection switching, and transmits the R-APS frame to an adjacent node. The RPL owner node, having received the R-APS frame, releases a block of the RPL and performs protection switching by flushing an FDB, and when another node also receives an R-APS frame, the other node flushes an FDB, thereby performing protection switching. A node having flushed an FDB newly forms the FDB by MAC learning with a received data frame. In this case, due to traffic congestion, in a node, a data frame may be delayed more than the R-APS frame. Thereby, when the FDB is flushed at the node and then a problematic data frame is received later due to a delay of the data frame, the FDB of the node may not reflect the changed network topology.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method of flushing an FDB having advantages of allowing formation of a correct FDB, even if a data frame is delayed more frequently than a protection switching frame in an Ethernet ring network.

An exemplary embodiment of the present invention provides a method in which a node of an Ethernet ring network flushes an FDB, the method including: operating a timer for delaying flushing of the FDB when a topology of the ring network is changed; and flushing the FDB when the timer is terminated.

The method may further include forwarding a data frame in a queue state at the node to an adjacent node while the timer operates.

The method may further include, when the topology is changed with a block change at the node: generating a protection switching frame according to the block change; and transmitting the protection switching frame to an adjacent node, wherein the protection switching frame may include information that requests flushing of the FDB.

The operating of a timer may include receiving a protection switching frame that requests flushing of the FDB, and operating the timer after receiving the protection switching frame.

The operating of a timer may further include forwarding the received protection switching frame to an adjacent node.

The operating of a timer may further include setting an operating time period of the timer in consideration of a delay of the data frame.

The operating time period may be set to a time period longer than a maximum delay required until the data frame transferred before the topology is changed is processed at the node.

The operating time period may be set to the same time period at all nodes of the ring network, and the operating time period may be set to a time period longer than a maximum delay of the data frame in the ring network.

Another embodiment of the present invention provides a method in which a node of an Ethernet ring network flushes an FDB, the method including: receiving a protection switching frame that requests flushing of the FDB; flushing the FDB after the protection switching frame is received; and forwarding a data frame in a queue state at the node and then forwarding the protection switching frame to an adjacent node.

The method may further include setting a processing order of the protection switching frame to not be higher than a processing order of the data frame, wherein the forwarding of a data frame may include forwarding the protection switching frame and the data frame to an adjacent node according to a processing order of the protection switching frame and a processing order of the data frame.

When the processing order of the protection switching frame is identical to a processing order of the data frame, the forwarding of a data frame may include forwarding the data frame and the protection switching frame to an adjacent node according to a reception order of the data frame and the protection switching frame.

Yet another embodiment of the present invention provides a method in which a node of an Ethernet ring network flushes an FDB, the method including: receiving a protection switching frame that requests flushing of the FDB; deleting a data frame in a queue state at the node after receiving the protection switching frame; and flushing the FDB after receiving the protection switching frame.

The method may further include forwarding the protection switching frame to an adjacent node.

According to an exemplary embodiment of the present invention, even if a data frame is delayed more than a protection switching frame, the data frame can form an FDB without an error at a node.

### BRIEF DESCRIPTION OF THE DRAWINGS

FIG. 1 is a flowchart illustrating a state in which an FDB is flushed when a signal failure occurs in an Ethernet ring network.

FIGS. 2 and 3 are flowcharts illustrating a method of flushing an FDB after operating a flushing delay timer according to an exemplary embodiment of the present invention.

FIG. 4 is a flowchart illustrating a method of flushing an FDB by setting a frame processing order according to another exemplary embodiment of the present invention.

FIGS. 5 and 6 are flowcharts illustrating a method of deleting a data frame in a queue state and flushing an FDB according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising” will be understood to imply the inclusion of stated elements but not the exclusion of any other elements.

Now, a method of flushing an FDB in an Ethernet ring network according to an exemplary embodiment of the present invention will be described in detail.

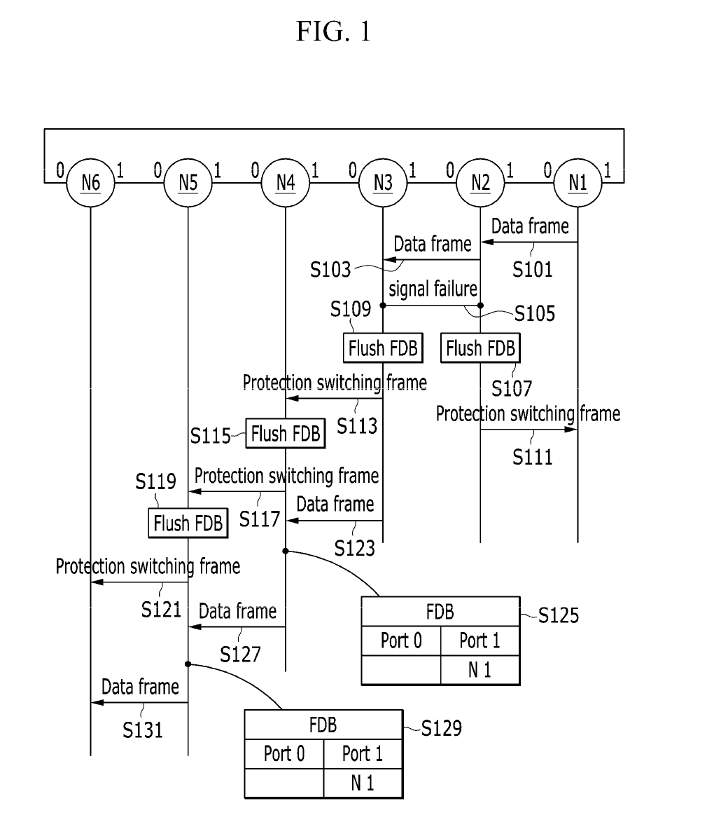

FIG. 1 is a flowchart illustrating a state in which flushes an FDB is flushed when a signal failure occurs in an Ethernet ring network.

Referring to FIG. 1, the Ethernet ring network includes a plurality of nodes, for example, six nodes N1-N6 that are connected in a ring form. Ports 0 of each node are connected to ports 1 of adjacent nodes in one direction, for example, in a clockwise direction, and ports 1 of each node are connected to ports 0 of adjacent nodes in the other direction, for example, in a counterclockwise direction. In this case, a ring protection link (RPL) may be set to a link that connects a port 1 of a node N1 and a port 0 of a node N6, and the node N1 may be an RPL owner node.

If it is assumed that a data frame is transmitted from the node N1 to the node N6, when the node N1 transmits the data frame through an unblocked port 0 (S101), a node N3 receives the data frame via a node N2 (S103).

Before the node N3 forwards the received data frame to a node N4, when a signal failure occurs between two nodes N2 and N3, a signal failed port is blocked (S105).

As the signal failed port is blocked, when a network topology is changed, the nodes N2 and N3 flush an FDB (S107 and S109). The nodes N2 and N3 generate and transmit a protection switching frame, for example, an R-APS frame including information that requests flushing of the FDB (S111 and S113).

The node N4 receives the protection switching frame and flushes the FDB (S115).

A node N5 receives the protection switching frame from the node N4 (S117) and flushes the FDB (S119). The node N5 forwards the received protection switching frame to the node N6 (S121).

In this case, due to a delay in data frame processing, the node N3 may forward a data frame after forwarding the protection switching frame (S123). Accordingly, the node N4 flushes the FDB (S115) and then receives the data frame (S123). As a result of a signal failure that is generated between the nodes N2 and N3, even if the node N1 exists in a direction of a port 0 of the node N4, the node N4 receives the data frame through the port 1, and thus the node N4 forms an FDB by recording that the node N1 exists in a direction of the port 1 (S125).

The node N5 receives a data frame from the node N4 (S127) and forms an FDB using the data frame (S129). Although the node N1 exists in a direction of the port 0 of the node N5, the node N5 receives a data frame through the port 1 and thus the N5 records that the node N1 exists in a direction of the port 1. The node N5 forwards the data frame to an adjacent node (S131).

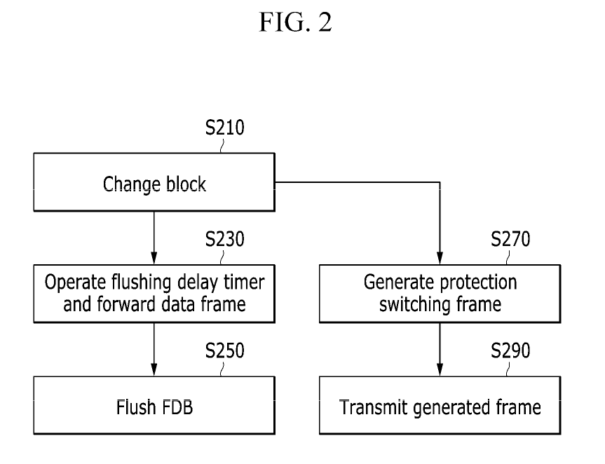

In this way, due to a delay at the node N3, a data frame is forwarded later than a protection switching frame (S123) to the nodes N4 and N5. So the node N4 and N5 may form an wrong FDB. Exemplary embodiments that solve such a problem will be described in detail with reference to FIGS. 2 to 6.

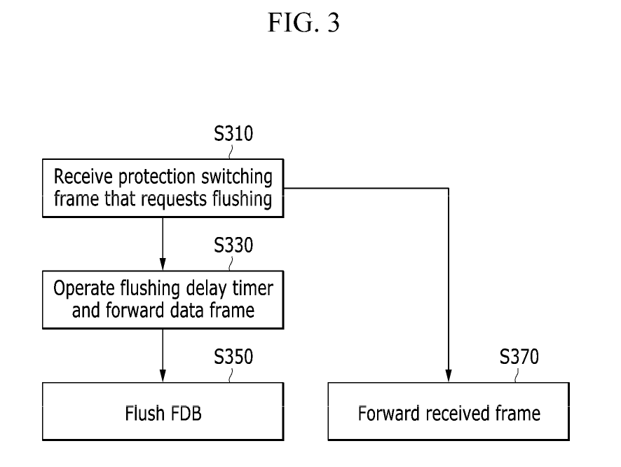

FIGS. 2 and 3 are flowcharts illustrating a method of flushing an FDB according to an exemplary embodiment of the present invention.

First, referring to FIG. 2, as a block is changed at a corresponding node (S210), when a network topology is changed, a node having the changed block operates a timer (hereinafter a “flushing delay timer”) for delaying flushing of an FDB (S230), and when the timer is terminated, the node flushes the FDB (S250). While flushing is delayed due to operation of the flushing delay timer, when a data frame exists in a queue state, the node forwards the data frame (S230). Because the block is changed (S210), the node generates and transmits a protection switching frame for notifying another node of the change of the block (S270 and S290). The protection switching frame may be an R-APS frame, and includes information that requests flushing of an FDB in order to reflect a changed topology. A case where the block is changed at the node (S210) may be, for example, a case of blocking a corresponding port when a signal failure has occurred in a link that is connected to a node, a case of blocking a corresponding port by a forced switching or a case of blocking an RPL after failure recovery in an RPL owner node.

Next, referring to FIG. 3, the node receives a protection switching frame that requests flushing of an FDB (S310), thereby knowing that a network topology is changed. Therefore, before the node flushes an FDB in order to reflect a changed topology, the node operates a flushing delay timer (S330), and when the timer is terminated, the node flushes the FDB (S350). While flushing is delayed due to operation of the timer, when a data frame exists in a queue state, the node forwards the data frame (S330). The node forwards the received protection switching frame to an adjacent node (S370).

The node may set an operating time period of a flushing delay timer to flush an FDB after processing a data frame that may form an wrong FDB while the flushing delay timer operates. For this reason, in consideration of a delay in which the data frame passes through the node, an operating time period of the flushing delay timer may be set.

According to an exemplary embodiment of the present invention, an operating time period of the flushing delay timer may be set longer than a maximum delay required until a data frame, particularly a data frame that is transferred before a topology is changed, is processed at a node that receives the data frame.

According to another exemplary embodiment of the present invention, at all nodes of a ring network, an operating time period of a flushing delay timer may be set to the same time period. In this case, in an entire ring network, an operating time period of a flushing delay timer is set to a time period longer than a delay of a data frame.

In this way, in the exemplary embodiment that is described with reference to FIGS. 2 and 3, because a node flushes an FDB after a predetermined time period, even if a data frame is delayed, the data frame is not used for forming an FDB.

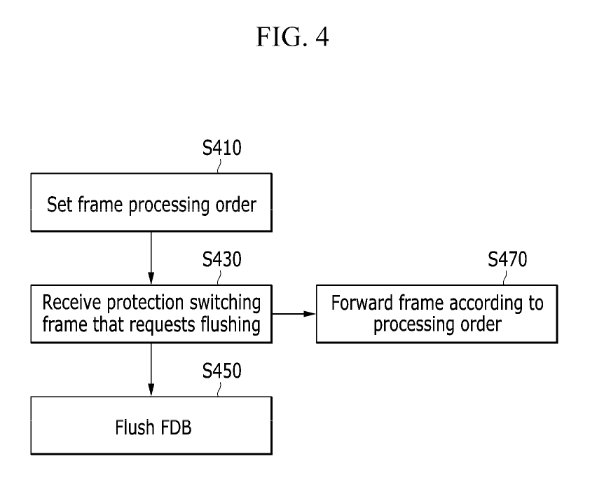

FIG. 4 is a flowchart illustrating a method of flushing an FDB according to another exemplary embodiment of the present invention.

Referring to FIG. 4, the node sets a frame processing order (S410). Thereafter, when the node receives a protection switching frame that requests flushing (S430), the node flushes an FDB (S450). The node forwards the frame according to a frame processing order (S470).

In this case, a processing order of the protection switching frame is set to not be higher than a processing order of the data frame at step S410. If a processing order of the protection switching frame is set to be lower than a processing order of the data frame, when a data frame is in a queue state, the node forwards a protection switching frame to an adjacent node after forwarding the data frame at step S470. When a delay occurring in a link that connects a node and a node is equally applied to frames, the adjacent node receives a protection switching frame after receiving a data frame and thus may not receive a data frame that can form a wrong FDB after flushing the FDB. When a processing order of the protection switching frame and a processing order of the data frame are equally set, the node can forward a frame in a first in first out (FIFO) method. Therefore, even if the protection switching frame and the data frame have the same priority order, because a data frame that is transferred to a path before a topology is changed among data frames can forward earlier than the protection switching frame, an error of the FDB may not occur due to a data frame that is transferred to a path before a topology is changed.

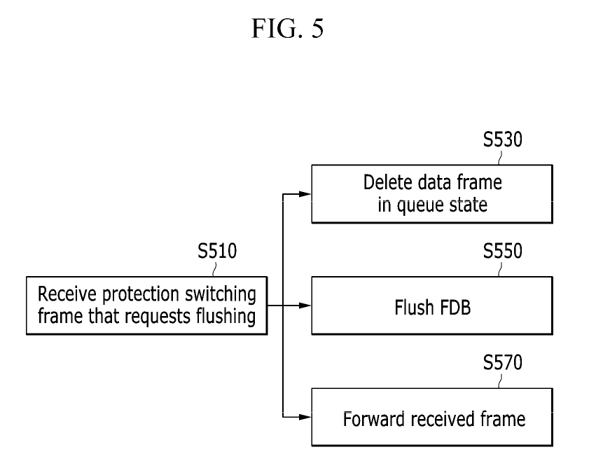

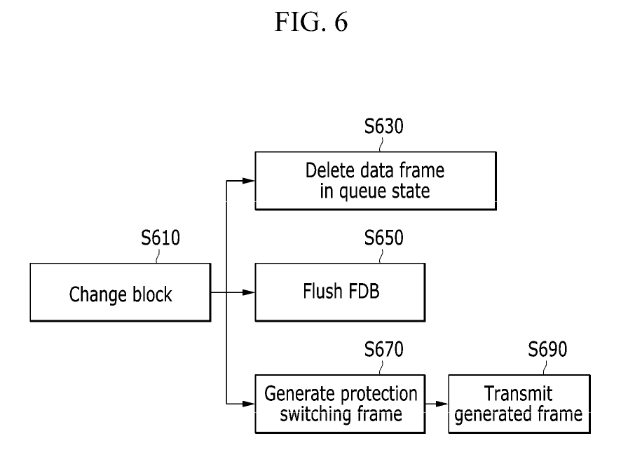

FIGS. 5 and 6 are flowcharts illustrating a method of flushing an FDB according to another exemplary embodiment of the present invention.

First, referring to FIG. 5, when the node receives a protection switching frame that requests flushing a FDB (S510), the node flushes the FDB (S550), and the node forwards the received protection switching frame to an adjacent node (S570). When the node receives a protection switching frame at step S510, if a data frame is in a queue state, the node deletes the data frame (S530) and does not forward the data frame to another node.

Next, referring to FIG. 6, when a block is changed at the node (S610), the node flushes an FDB thereof (S650) and generates and transmits a protection switching frame for notifying another node that the block is changed (S670 and S690). When the block is changed, if a data frame is in a queue state, the node deletes the data frame (S630).

In this way, when a network topology is changed, because a data frame in a queue state is also deleted together with flushing of an FDB, an adjacent node receives only the protection switching frame and does not receive a data frame, particularly a data frame that is transferred to a path before a topology is changed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a node of an Ethernet ring network flushes a filtering database (FDB), the method comprising:
operating a timer for delaying flushing of the FDB when a topology of the ring network is changed; and
flushing the FDB when the timer is terminated.

2. The method of claim 1, further comprising forwarding a data frame in a queue state at the node to an adjacent node while the timer operates.

3. The method of claim 1, further comprising, when the topology is changed with a block change at the node:
generating a protection switching frame according to the block change; and
transmitting the protection switching frame to an adjacent node,
wherein the protection switching frame comprises information that requests flushing of the FDB.

4. The method of claim 1, wherein the operating of a timer comprises:
receiving a protection switching frame that requests flushing of the FDB; and
operating the timer after receiving the protection switching frame.

5. The method of claim 4, wherein the operating of a timer further comprises forwarding the received protection switching frame to an adjacent node.

6. The method of claim 1, further comprising setting an operating time period of the timer in consideration of a delay of the data frame.

7. The method of claim 6, wherein the operating time period is set to a time period longer than a maximum delay required until the data frame transferred before the topology is changed is processed at the node.

8. The method of claim 6, wherein the operating time period is set to the same time period at all nodes of the ring network.

9. The method of claim 8, wherein the operating time period is set to a time period longer than a maximum delay of the data frame in the ring network.

10. A method in which a node of an Ethernet ring network flushes an FDB, the method comprising:
receiving a protection switching frame that requests flushing of the FDB;
flushing the FDB after the protection switching frame is received; and
forwarding a data frame in a queue state at the node and then forwarding the protection switching frame to an adjacent node.

11. The method of claim 10, further comprising setting a processing order of the protection switching frame to not be higher than a processing order of the data frame,
wherein the forwarding of a data frame comprises forwarding the protection switching frame and the data frame to an adjacent node according to a processing order of the protection switching frame and a processing order of the data frame.

12. The method of claim 11, wherein when the processing order of the protection switching frame is identical to a processing order of the data frame, and
the forwarding of a data frame comprises forwarding the data frame and the protection switching frame to an adjacent node according to a reception order of the data frame and the protection switching frame.

13. A method in which a node of an Ethernet ring network flushes an FDB, the method comprising:
receiving a protection switching frame that requests flushing of the FDB;
deleting a data frame in a queue state at the node after receiving the protection switching frame; and
flushing the FDB after receiving the protection switching frame.

14. The method of claim 13, further comprising forwarding the protection switching frame to an adjacent node.
